(19) United States
(12) Patent Application Publication
(10) Pub. No.: US 2025/0379709 A1
(43) Pub. Date: Dec. 11, 2025

(54) CLUSTERING AND POWER ALLOCATION FOR MULTI-TRP JOINT TRANSMISSION

(71) Applicant: Samsung Electronics Co., Ltd., Suwon-si (KR)

(72) Inventors: Yunseong Cho, Frisco, TX (US); R A Nadisanka Perera Rupasinghe, McKinney, TX (US); Gilwon Lee, McKinney, TX (US); Yang Li, Plano, TX (US); Jianzhong Zhang, Dallas, TX (US)

(21) Appl. No.: 19/059,146

(22) Filed: Feb. 20, 2025

Related U.S. Application Data
(60) Provisional application No. 63/657,665, filed on Jun. 7, 2024.

(51) Int. Cl. H04L 5/00; H04B 7/024; H04J 11/00; H04W 48/20

(52) U.S. Cl. CPC H04L 5/0073; H04B 7/024; H04J 11/005; H04W 48/20

(57) ABSTRACT

A method and device for clustering and power allocation for multi-TRP transmission. A method comprises providing multi-tier clustering to enable joint transmission across multiple transmit-receive-point (TRP) sets. The method includes utilizing one or more 2^{nd}-tier clusters located in an intersection of one or more adjacent 1^{st}-tier clusters to mitigate interference at cluster edges, and providing dynamic cluster selection to enable the joint transmission across the multiple TRPs while mitigating interference at cluster edges based on selecting a tailored cluster with respect to a signal power of each user equipment (UE) within the 1^{st}-tier clusters.

### CROSS-REFERENCE TO RELATED APPLICATION(S) AND CLAIM OF PRIORITY

This application claims priority under 35 U.S.C. § 119 (e) to U.S. Provisional Patent Application No. 63/657,665 filed on Jun. 7, 2024, which is hereby incorporated by reference in its entirety.

### TECHNICAL FIELD

This disclosure relates generally to wireless communication, and more specifically to clustering and power allocation for multi-transmit-receive point (TRP) transmission.

### BACKGROUND

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

One way to further improve the performance of wireless communication systems is by increasing the number of available transceiver units (TXRUs). However, the two adjacent antennas are anticipated to maintain a critical spacing of at least a half-wavelength to overcome the space correlation at two neighboring elements with regard to small-scale fading in deployment environments. Due to the aforementioned factors, increasing the number of antenna elements may be practically infeasible, and may cause challenges in deployment.

### SUMMARY

Embodiments of the present disclosure provide methods and apparatuses for clustering and power allocation for multi-TRP transmission.

In one embodiment, a method for clustering and power allocation for multi-TRP transmission providing multi-tier clustering to enable joint transmission across multiple transmit-receive-point (TRP) sets. The method includes utilizing one or more 2nd tier clusters located in an intersection of one or more adjacent 1st-tier clusters to mitigate interference at cluster edges, and providing dynamic cluster selection to enable the joint transmission across the multiple TRPs while mitigating interference at cluster edges based on selecting a tailored cluster with respect to a signal power of each user equipment (UE) within the 1st-tier clusters.

In another embodiment, a system comprises one or more 2nd-tier clusters located in an intersection of one or more adjacent 1st-tier clusters to mitigate interference at cluster edges. The system is configured to: provide multi-tier clustering to enable joint transmission across multiple transmit-receive-point (TRP) sets; and provide dynamic cluster selection to enable the joint transmission across the multiple TRP sets while mitigating interference at cluster edges based on selecting a tailored cluster with respect to a signal power of each user equipment (UE) within the 1st-tier clusters.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with”, as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example of horizontal TRP expansion according to embodiments of the present disclosure;

FIG. 5 illustrates an example of back-to-back TRP configuration in a bidirectional-cuboid-array (BCA) according to embodiments of the present disclosure;

FIG. 6 illustrates an example of 3D-massive multiple input multiple output (MMU) in a base station site according to embodiments of the present disclosure;

FIG. 7 illustrates an example of 3D-MMU tier-1 clustering for a 2-ring hexagonal cell layout according to embodiments of the present disclosure;

FIG. 8 illustrates an example of cluster-edges of tier-1 clusters according to embodiments of the present disclosure;

FIG. 9 illustrates an example of a 1-ring hexagonal cell layout covered by both tier-1 clustering and tier-2 clustering according to embodiments of the present disclosure;

FIGS. 10A and 10B illustrate an example of a UE being offloaded from a tier-1 cluster to a tier-2 cluster according to embodiments of the present disclosure;

FIG. 11 illustrates an example of a geometric distribution of UEs according to embodiments of the present disclosure;

FIG. 12 illustrates an example of dynamic tier-1 cluster selection according to embodiments of the present disclosure;

FIG. 13 illustrates an example of a geometric distribution for UEs connected to a particular cell according to embodiments of the present disclosure; and

FIG. 14 illustrates an example method for clustering and power allocation for multi-TRP transmission according to embodiments of the present disclosure.

### DETAILED DESCRIPTION

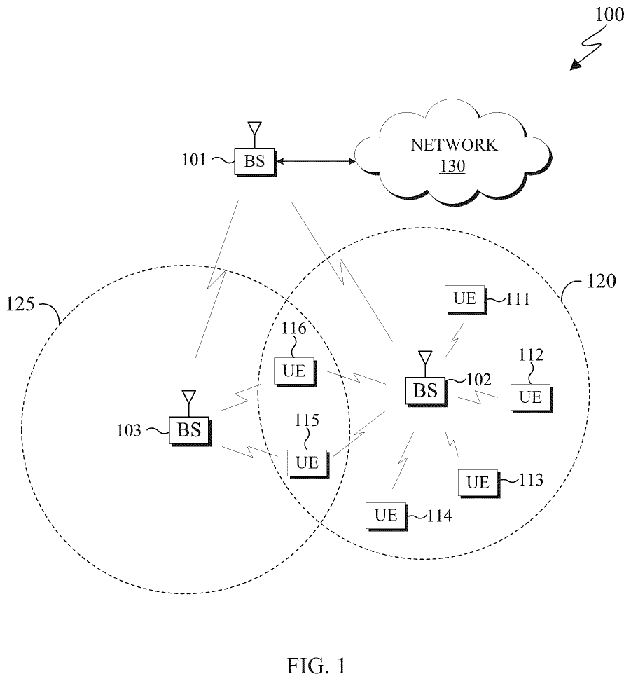

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] 3GPP TS 36.211 v16.4.0, “E-UTRA, Physical channels and modulation”; [2] 3GPP TS 36.212 v16.4.0, “E-UTRA, Multiplexing and Channel coding”; [3] 3GPP TS 36.213 v16.4.0, “E-UTRA, Physical Layer Procedures”; [4] 3GPP TS 36.321 v16.3.0, “E-UTRA, Medium Access Control (MAC) protocol specification”; [5] 3GPP TS 36.331 v16.3.0, “E-UTRA, Radio Resource Control (RRC) Protocol Specification”; [6] 3GPP TS 38.211 v16.4.0, “NR, Physical channels and modulation;” [7] 3GPP TS 38.212 v16.4.0, “NR, Multiplexing and Channel coding”; [8] 3GPP TS 38.213 v16.4.0, “NR, Physical Layer Procedures for Control”; [9] 3GPP TS 38.214 v16.4.0, “NR, Physical Layer Procedures for Data”; [10] 3GPP TS 38.215 v16.4.0, “NR, Physical Layer Measurements”; [11] 3GPP TS 38.321 v16.3.0, “NR, Medium Access Control (MAC) protocol specification”; and [12] 3GPP TS 38.331 v16.3.1, “NR, Radio Resource Control (RRC) Protocol Specification”.

Embodiments of the present disclosure recognize that to increase the number of TXRUs, one may choose to horizontally append two TRPs. However, this expansion results in a significant increase in form factor size. To reduce massive MIMO unit (MMU) size, two layers of MMU antenna panels facing the same direction can be stacked; however, this may not be feasible due to the signal from the rear TRP attenuating significantly because of the ground-plane blockage issue from the front TRP. One may choose to reduce the antenna spacing to employ more ports in the same form factor size; however, this triggers loss in peak gain.

In addition, embodiments of the present disclosure recognize that a cellular network is based on the concept of dividing the geographic area into smaller regions or sectors, where user devices in each region are served by at least one TRP. Assuming each antenna element has the radiation power pattern with 65° half-power beamwidth, each gNodeB deploys three TRPs, each of which primarily handles a fixed 120° sector. This type of sectorization needs to be evolved such that flexible sectorization is available.

Further, embodiments of the present disclosure recognize that when dividing the cell layout with a finer granularity, a more diversified antenna angle orientation can be observed. While being compatible with other cell associations, a set of coordination TRPs, i.e., cluster, can be developed to jointly operate UEs. This results in both a higher signal power and a lower interference level; however, some UEs may suffer from inter-cluster interference. In addition, the precoders used from cooperating TRPs need to be normalized such that one or multiple system requirement are satisfied.

Accordingly, various embodiments of the present disclosure can provide methods and apparatuses for clustering and power allocation schemes of 3D-MMU architecture that enhances TXRU plurality without further increasing the horizontal dimension. To enable joint transmission across multi-TRPs while avoiding cell-edge problems, various embodiments of the present disclosure provide the notion of multi-tier clustering and dynamic cluster selection. Further, various embodiments of the present disclosure can provide power allocation schemes across multiple TRPs such that one or multiple significant constraints are satisfied. Further still, various embodiments of the present disclosure can provide multi-tier clustering to enable joint transmission across multiple TRPs while avoiding cell-edge problems by utilizing 2nd-tier clusters located in an intersection of adjacent 1st-tier clusters. In addition, various embodiments of the present disclosure can provide dynamic cluster selection to enable joint transmission across multiple TRPs while avoiding cell-edge problems by selecting a tailored cluster with respect to each UE's signal power. Further still, various embodiments of the present disclosure can provide mechanisms for handling one or more power allocation schemes across multiple TRPs to satisfy one or more constraints.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

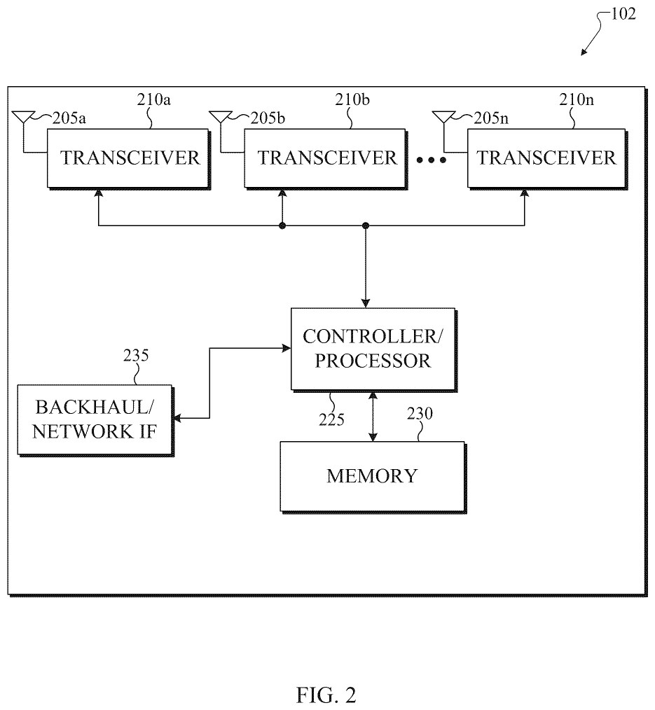

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 or the transceivers 210a-210n may include circuitry and/or programming for facilitating clustering and power allocation for multi-TRP transmission. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

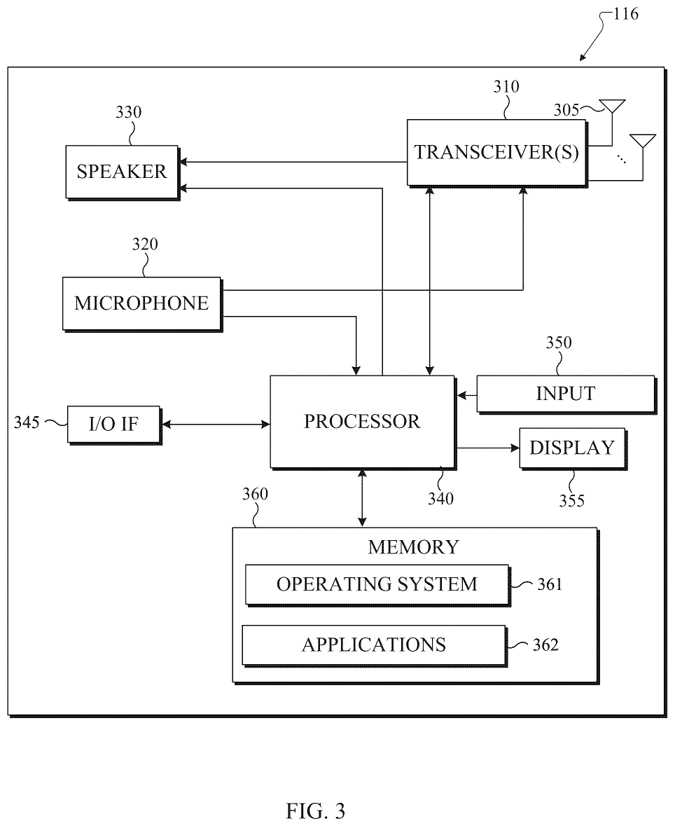

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 can include circuitry and/or programming for facilitating clustering and power allocation for multi-TRP transmission. The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

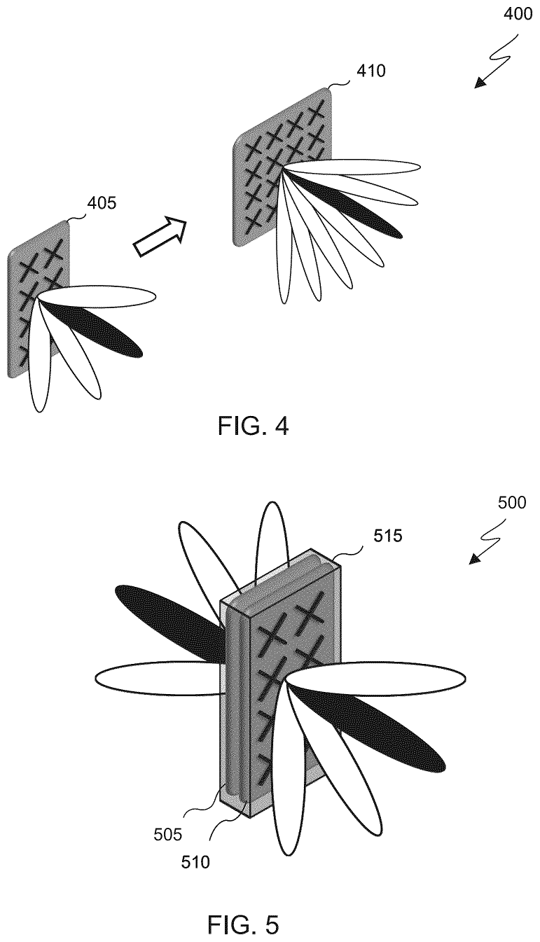

FIG. 4 illustrates an example of horizontal TRP expansion 400 according to embodiments of the present disclosure. The embodiment of the horizontal TRP expansion 400 shown in FIG. 4 is for illustration only. Other embodiments of the horizontal TRP expansion 400 could be used without departing from the scope of this disclosure.

As illustrated in FIG. 4, the TRP 405 may increase the number of TXRUs horizontally in order to produce the horizontally expanded TRP 410 shown in FIG. 4. Both the TRP 405 and the TRP 410 are denoted as two-dimensional (2D)-MMU because each TRP can be conceptually perceived as a uniform-rectangular-array.

FIG. 5 illustrates an example of back-to-back TRP configuration in a BCA 500 according to embodiments of the present disclosure. The embodiment of the back-to-back TRP configuration in a BCA 500 shown in FIG. 5 is for illustration only. Other embodiments of the back-to-back TRP configuration in a BCA 500 could be used without departing from the scope of this disclosure.

In some embodiments as illustrated in FIG. 5, TRP 505 and TRP 510 can be disposed in a back-to-back configuration in which antenna elements of the TRP 505 are positioned to radiate in an opposite direction from antenna elements of the TRP 510 in one BCA 515 and maintain a certain difference in facing angle. In some embodiments, the difference in facing angle is 180°.

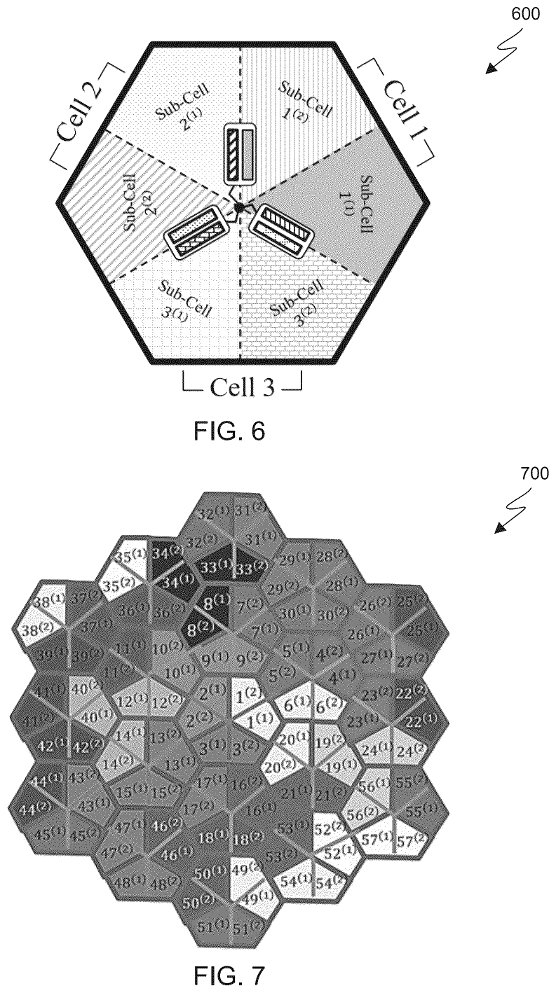

FIG. 6 illustrates an example of 3D-MMU in a base station site 600 according to embodiments of the present disclosure. The embodiment of the example of 3D-MMU in a base station site 600 shown in FIG. 6 is for illustration only. Other embodiments of the example of 3D-MMU in a base station site 600 could be used without departing from the scope of this disclosure.

A cellular network is based on the concept of dividing the geographic area into smaller regions where a user equipment (UE) in each region is served by at least one associated TRP. The pair of back-to-back TRPs are deployed in one 3D-MMU package as shown in FIG. 5. Since two TRPs are facing the opposite direction, the inter-TRP mutual coupling within each 3D-MMU package is marginal.

As illustrated in FIG. 6, multiple 3D-MMU packages are used in one particular site. In this embodiment, to make 3D-MMU compatible with other cell associations, each site is divided into three 120° cells where each cell i includes two adjacent 60° sub-cells i⁽¹⁾ and i⁽²⁾. Considering the sub-cell separation, the initial cell association relates the k-th UE to cell sₖ when sₖ is determined as:

$${s}_{k} = {arg max}_{i ∈ {ℳ}_{k}} ( {γ}_{k , {i}^{( 1 )}} + {γ}_{k , {i}^{( 2 )}} ) \qquad ( 1 )$$

where [symbol] is the reference signal received power (RSRP) received at UE k from sub-cell [symbol] and [symbol] is the set of measurable cells of UE k. The prime TRP of UE k refers to the TRP from which UE k receives the highest RSRP.

FIG. 7 illustrates an example of 3D-MMU tier-1 clustering for a 2-ring hexagonal cell layout 700 according to embodiments of the present disclosure. The embodiment of the example of 3D-MMU tier-1 clustering for a 2-ring hexagonal cell layout 700 shown in FIG. 7 is for illustration only. Other embodiments of the example of 3D-MMU tier-1 clustering for a 2-ring hexagonal cell layout 700 could be used without departing from the scope of this disclosure.

In some embodiments, when a distributed unit (DU) is connected to multiple sites, separate sites can optionally cooperate to form a coordination TRP set. Since each coordination TRP set needs to be compatible with other cell associations in equation (1) while delivering diversified angle orientation, each tier-1 cluster can be defined as the union of three cells (equivalently, six sub-cells) as shown in FIG. 7. For example, cells 1, 6, and 20 (equivalently, sub-cells 1⁽¹⁾, 1⁽²⁾, 6⁽¹⁾, 6⁽²⁾, 20⁽¹⁾, and 20⁽²⁾) in FIG. 7 are configured to jointly support UEs initially attached to either cell 1, 6, or 20. This clustering can be expanded to the entire hexagonal grid as shown in FIG. 7. By performing coherent joint transmission (CJT) over six neighboring TRPs, the newly attached TRPs are converted from dominant interfering cells to serving cells, thereby significantly improving the signal quality in most cases. In some embodiments, each tier-1 cluster includes adjacent sub-cells from three different cell site sectors.

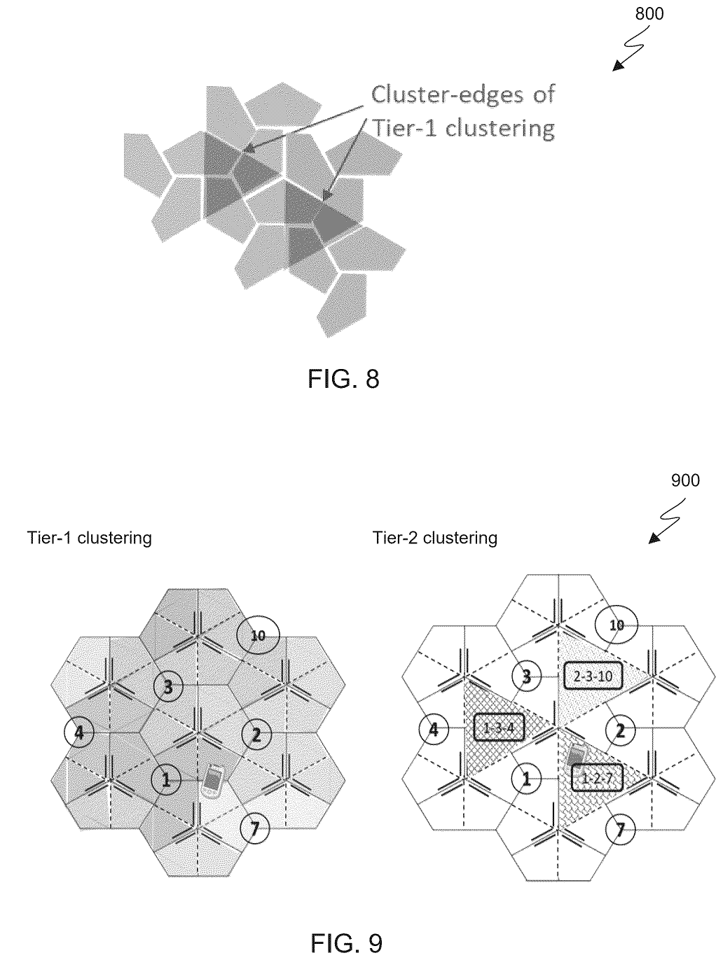

FIG. 8 illustrates an example of cluster-edges of tier-1 clusters 800 according to embodiments of the present disclosure. The embodiment of the example of cluster-edges of tier-1 clusters 800 shown in FIG. 8 is for illustration only. Other embodiments of the example of cluster-edges of tier-1 clusters 800 could be used without departing from the scope of this disclosure.

As illustrated in FIG. 8, in some embodiments, due to the fixed shape of tier-1 clusters, cluster-edge regions are inevitably introduced. UEs located in such fixed shape tier-1 clusters (e.g., triangle) may receive high interference from neighboring tier-1 cluster sub-cells. Cells expected to locate in the cluster-intersection typically have an even sub-cell number, i.e., i⁽²⁾ as shown in FIG. 7 and FIG. 8.

FIG. 9 illustrates an example of a 1-ring hexagonal cell layout covered by both tier-1 clustering and tier-2 clustering 900 according to embodiments of the present disclosure. The embodiment of the example of a 1-ring hexagonal cell layout covered by both tier-1 clustering and tier-2 clustering 900 shown in FIG. 9 is for illustration only. Other embodiments of the example of a 1-ring hexagonal cell layout covered by both tier-1 clustering and tier-2 clustering 900 could be used without departing from the scope of this disclosure.

As illustrated in FIG. 9, in some embodiments, a tier-1 cluster is defined with six neighboring TRPs whereas a tier-2 cluster is defined with three neighboring TRPs which form a triangular shape.

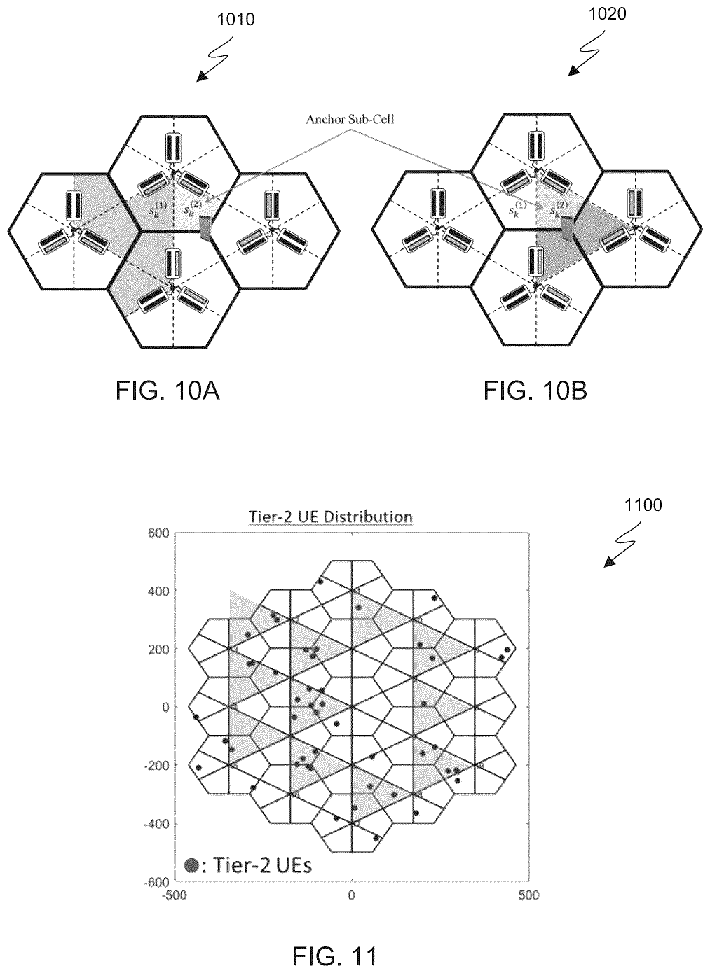

FIGS. 10A and 10B illustrate an example of a UE being offloaded from a tier-1 cluster 1010 to a tier-2 cluster 1020 according to embodiments of the present disclosure. The embodiment of the example of a UE being offloaded from a tier-1 cluster 1010 to a tier-2 cluster 1020 shown in FIGS. 10A and 10B is for illustration only. Other embodiments of the example of a UE being offloaded from a tier-1 cluster 1010 to a tier-2 cluster 1020 could be used without departing from the scope of this disclosure.

In some embodiments, although the tier-1 clustering is beneficial to most UEs, a UE located close to the boundary of tier-1 clusters is likely to observe high inter-cluster interference since the prime TRP is far away from the UE. In this case, the second highest RSRP can be obtained from the neighboring tier-1 cluster and its value can be as high as the RSRP from the prime TRP as shown in FIG. 10A. Accordingly, a triangular tier-2 cluster as shown in FIG. 10B can be defined to offload the UE and mitigate severe inter-cluster interference in a user-centric manner.

In some embodiments, noting that sₖ⁽²⁾ is anchored between tier-1 and tier-2 clusters, a determination can be made whether to offload to tier-2 cluster by comparing the sum RSRP of the associated tier-2 cluster where the anchor sub-cell acts as the pivot between two tiers.

FIG. 11 illustrates an example of a geometric distribution of UEs 1100 according to embodiments of the present disclosure. The embodiment of the example of a geometric distribution of UEs 1100 shown in FIG. 11 is for illustration only. Other embodiments of the example of a geometric distribution of UEs 1100 could be used without departing from the scope of this disclosure.

As illustrated, FIG. 11 shows the distribution of UEs that are transferred to tier-2 clusters since the sum RSRP of the associated tier-2 cluster is higher than the one of the associated tier-1 cluster. It can be shown that most of such UEs are located in the highlighted triangles which are the collection of tier-2 clusters.

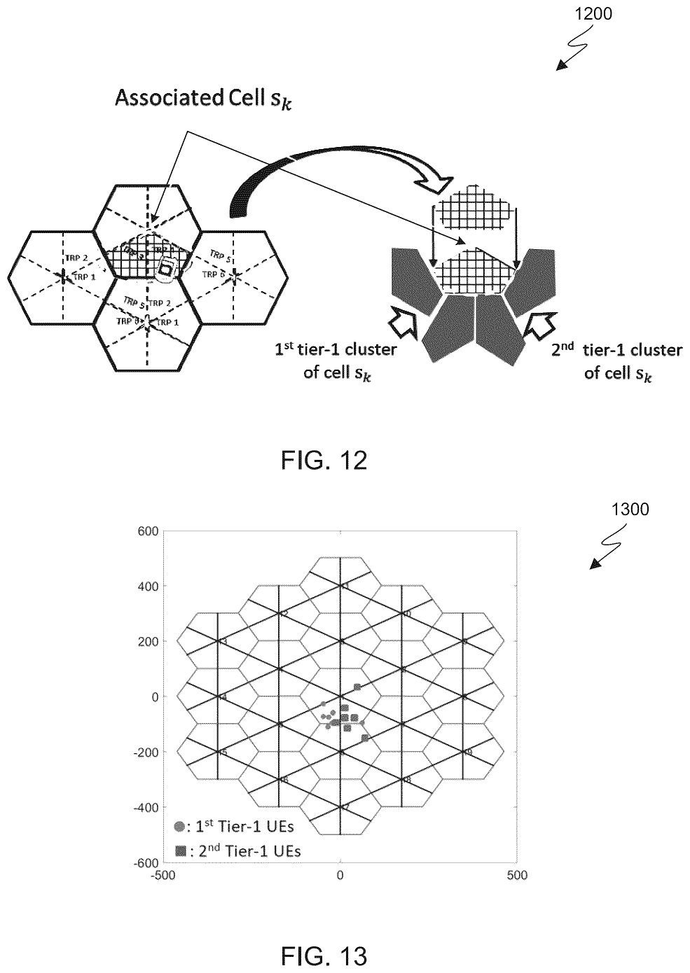

FIG. 12 illustrates an example of dynamic tier-1 cluster selection 1200 according to embodiments of the present disclosure. The embodiment of the example of dynamic tier-1 cluster selection 1200 shown in FIG. 12 is for illustration only. Other embodiments of the example of dynamic tier-1 cluster selection 1200 could be used without departing from the scope of this disclosure.

### 3D-MMU Dynamic Cluster Selection for Multi-TRP CJT

As illustrated in FIG. 12, in some embodiments, dynamic tier-1 cluster selection may be provided. Dynamic tier-1 cluster selection is a mechanism in which the initially associated cell has freedom to be attached to either a 1st tier-1 cluster or a 2nd tier-1 cluster, where both of the 1st tier-1 cluster and the 2nd tier-1 cluster are configured to contain six neighboring TRPs. In one embodiment, the 2nd tier-1 cluster is a superset of a tier-2 cluster. This can eventually remove the cluster-edge issue described herein.

FIG. 13 illustrates an example of a geometric distribution for UEs connected to a particular cell 1300 according to embodiments of the present disclosure. The embodiment of the example of a geometric distribution for UEs connected to a particular cell 1300 shown in FIG. 13 is for illustration only. Other embodiments of the example of a geometric distribution for UEs connected to a particular cell 1300 could be used without departing from the scope of this disclosure.

As illustrated, FIG. 13 shows the distribution of UEs that are initially attached to a particular cell, for example cell 3. Some UEs have higher sum RSRP from the 1^{st} tier-1 cluster of cell 3 whereas other UEs have higher sum RSRP from the 2^{nd} tier-1 cluster of cell 3. Since it tends to divide the two groups with respect to the border between sub-cell 3⁽¹⁾ and 3⁽²⁾, dynamic cluster selection provides a fair opportunity to both clusters, thereby improving a UEs' signal quality due to the enhanced flexibility.

### Power Allocation

Let the stacked channel between the k-th UE and a specific 3D-MMU cluster with N∈{3,6} TRPs with each having M TXRUs be

$${h}_{k} = {[ {( {h}_{k}^{1} )}^{T} , … , {( {h}_{k}^{N} )}^{T} ]}^{T} ∈ {ℂ}^{N M \times 1} .$$

Subsequently, the channel matrix from N TRPs to K associated UEs can be combined as:

$$H = [ {h}_{1} , … , {h}_{K} ] ∈ {ℂ}^{N M \times K} .$$

Note that H can be acquired through sounding reference signal for time division duplex or precoding matrix indicator for frequency division duplex. Assuming the use of a multi-user precoder, for example, a zero-forcing precoder of \hat{P}=H(H^{H}H)⁻¹, an unnormalized precoders can be constructed from N TRPs toward the k-th UE as:

$${\hat{p}}_{k} = {[ {( {\hat{p}}_{k}^{1} )}^{T} , … , {( {\hat{p}}_{k}^{N} )}^{T} ]}^{T} ∈ {ℂ}^{NM \times 1} ,$$

where \hat{p}ₖ is the k-column of \hat{P}.

In some embodiments, the unnormalized primitive precoders need to be normalized. A normalization factor

$${α}_{k}^{n}$$

can be variously defined where

$${α}_{k}^{n}$$

appears in the normalized precoder as:

$${p}_{k}^{n} = \frac{1}{{α}_{k}^{n}} {\hat{p}}_{k}^{n} .$$

Then, the normalized stacked precoder from N TRPs toward the k-th UE is defined as:

$${p}_{k} = {[ {( {p}_{k}^{1} )}^{T} , … , {( {p}_{k}^{N} )}^{T} ]}^{T} ∈ {ℂ}^{N M \times 1} .$$

$${α}_{k}^{n}$$

needs to be carefully designed such that the transmit power from each TRP is uniformly or ununiformly shared across K UEs. On top of that, the normalized precoder needs to satisfy one or multiple conditions of the following: 1) precoder structure is preserved for interference nulling, i.e., pₖ=η\hat{p}ₖ for an arbitrary scalar η; 2) total TRP power constraint of

$${\sum }_{n = 1}^{N} {‖ {p}_{k}^{n} ‖}^{2} \leq \frac{N}{K}$$

is preserved; 3) per-TRP power constraint of

$${\sum }_{k = 1}^{K} ‖ {p}_{k}^{n} ‖ \leq 1$$

is met for all n; and 4) per-TRP per-UE power constraint of

$${‖ {p}_{k}^{n} ‖}^{2} \leq \frac{1}{K}$$

is satisfied for an n and k. A system operator may choose one particular scheme based on their system requirement.

In some embodiments, equal power allocation is defined as

$${α}_{k}^{n} = \sqrt{K} ‖ {\hat{p}}_{k}^{n} ‖ .$$

This scheme guarantees uniform per-TRP per-UE power of 1/K and total TRP power of N/K for all TRPs, thereby utilizing the full resource of each TRP. However, since normalization factors are heterogeneously defined across TRPs, precoder structure is altered and interference may exist.

In some embodiments, flexible power allocation is defined as

$${α}_{k}^{n} = \sqrt{\frac{K}{N}} ‖ {\hat{p}}_{k} ‖ .$$

Since the normalization factor is defined regardless of n for a certain UE k, this scheme guarantees that precoder structure is preserved. Also, total TRP power of N/K is always met since normalization is obtained through the 2-norm of the stacked channel. However, the per-TRP per-UE power is unbalanced and biased toward the prime TRP of each UE. This means that the per-TRP per-UE power constraint is violated unless the exception case of

$$‖ {\hat{p}}_{k}^{n} ‖ = ‖ {\hat{p}}_{k}^{m} ‖$$

for all n and m where n≠m, is met, which is not feasible. Note that, in the exception case, the flexible power allocation is equivalent to the equal power allocation. Because of the per-TRP per-UE power violation, it can be inferred that the per-TRP power constraint is not guaranteed where the extreme case happens when all UEs select the same TRP as their prime TRP.

In some embodiments, prime power allocation is defined as

$${α}_{k}^{n} = \sqrt{K} {max}_{m ∈ \{ 1 , … , N \}} ‖ {\hat{p}}_{k}^{n} ‖ . Since {α}_{k}^{n}$$

is actually defined without reference to n, N TRPs associated with one particular UE k use the same scaling factor, thereby the precoder structure is unaltered. Note that the prime TRP of each UE k reports the transmit power of 1/K whereas the rest of the TRPs consume less power to operate in a more power-efficient manner. Therefore, this scheme satisfies total TRP transmit power, per-TRP transmit power, and per-TRP per-UE transmit power constraints. When all UEs designate the same TRP as their prime TRP as an extreme case, the highest total TRP power becomes N/K which is still acceptable.

In some embodiments, two-stage prime power allocation is defined. An intermediate precoder is derived by following the prime power allocation as:

$${\tilde{p}}_{k}^{n} = \frac{1}{{β}_{k}^{n}} {\hat{p}}_{k}^{n}$$

where

$${β}_{k}^{n} = \sqrt{K} {max}_{m ∈ \{ 1 , … , N \}} ‖ {\hat{p}}_{k}^{m} ‖ .$$

Noting that UEs are randomly distributed across the field and choose their prime TRP based on the reported RSRP, it is straightforward that one particular TRP is elected as the prime TRP by a small subset of UEs. This means that, under the original prime power allocation, each TRP does not fully utilize its power resource. To further reinforce power utilization, the second-stage of the two-stage prime power allocation is defined as:

$${p}_{k}^{n} = \frac{1}{{δ}_{k}^{n}} {\tilde{p}}_{k}^{n}$$

where

$${δ}_{k}^{n} = {max}_{m ∈ \{ 1 , … , N \}} \sqrt{{\sum }_{k = 1}^{K} {‖ {\tilde{p}}_{k}^{m} ‖}^{2}} . Note that {δ}_{k}^{n}$$

is less than or equal to 1 where the equality holds when all UEs identify the same TRP as their prime TRP. This additional process can guarantee that the TRP with the highest transmit power consumes a total TRP transmit power of 1. Since both steps are defined regardless of n, it is possible to maintain the precoder structure. Note that the total TRP power and per-TRP power constraints are preserved whereas the per-TRP per-UE power constraint is violated at a few TRPs, which results in non-uniform power allocation across UEs.

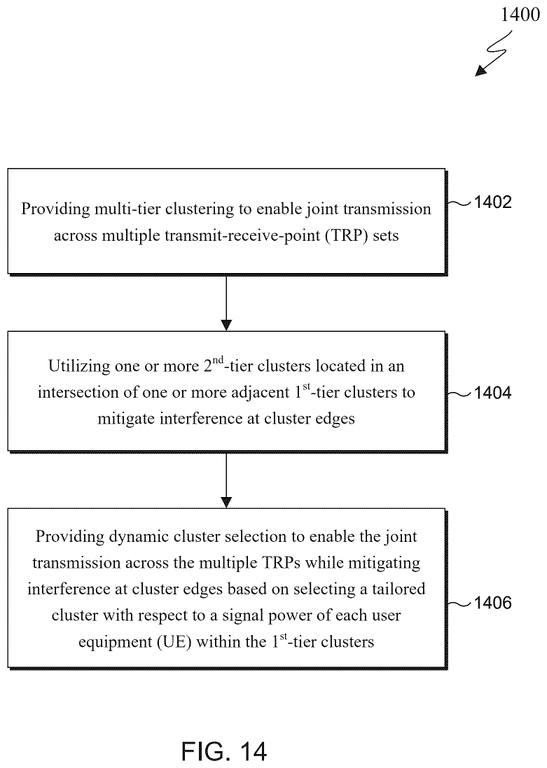

FIG. 14 illustrates an example method 1400 for clustering and power allocation for multi-TRP transmission according to embodiments of the present disclosure. The embodiment of an example method 1400 for clustering and power allocation for multi-TRP transmission shown in FIG. 14 is for illustration only. Other embodiments of an example method 1400 for clustering and power allocation for multi-TRP transmission could be used without departing from the scope of this disclosure.

As illustrated in FIG. 14, the method 1400 begins at step 1402, and includes providing multi-tier clustering to enable joint transmission across multiple transmit-receive-point (TRP) sets. At step 1404, the method includes utilizing one or more 2^{nd}-tier clusters located in an intersection of one or more adjacent 1^{st}-tier clusters to mitigate interference at cluster edges. At step 1406, the method includes providing dynamic cluster selection to enable the joint transmission across the multiple TRPs while mitigating interference at cluster edges based on selecting a tailored cluster with respect to a signal power of each user equipment (UE) within the 1^{st}-tier clusters.

In one embodiment, each TRP set comprises a first TRP and a second TRP in a back-to-back configuration in which antenna elements of the first TRP are positioned to radiate in an opposite direction from antenna elements of the second TRP.

In one embodiment, each 1^{st}-tier cluster is defined as a union of three cell site sectors from three different cell sites to provide 1^{st}-tier clustering; each cell site sector comprises two sub-cells; and each 1^{st}-tier cluster does not overlap with another 1^{st}-tier cluster.

In one embodiment, 2^{nd}-tier clustering is defined to allow cooperation of cell site sectors not facilitated by the 1^{st}-tier clustering; each 2^{nd}-tier cluster comprises a single sub-cell from each of three cell site sectors; and each 2^{nd}-tier cluster is within an intersection of three 1^{st}-tier clusters.

In one embodiment, the method includes defining a first set of 1^{st}-tier clusters and a second set of 1^{st}-tier clusters; each of the first set of 1^{st}-tier clusters and the second set of 1^{st}-tier clusters has six neighboring TRPs; an initially associated cell site is configured to be attached to either one of the first set of 1^{st} tier clusters or one of the second set of 1^{st} tier clusters by choosing which other cell sites to append; and each of the second set of 1^{st}-tier clusters is a superset of an associated 2^{nd}-tier cluster.

In one embodiment, the method includes utilizing one or more power allocation schemes across multiple TRPs to satisfy one or more constraints.

In one embodiment, the one or more power allocation schemes comprises equal power allocation across TRPs or weighted equal power allocation across TRPs.

In one embodiment, the one or more power allocation schemes comprises flexible power allocation across TRPs.

In one embodiment, the one or more power allocation schemes comprises prime power allocation or local prime allocation across TRPs.

In one embodiment, the one or more power allocation schemes comprises two-stage prime power allocation across TRPs.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
providing multi-tier clustering to enable joint transmission across multiple transmit-receive-point (TRP) sets, including:
utilizing one or more 2^{nd}-tier clusters located in an intersection of one or more adjacent 1^{st}-tier clusters to mitigate interference at cluster edges; and
providing dynamic cluster selection to enable the joint transmission across the multiple TRP sets while mitigating interference at cluster edges based on selecting a tailored cluster with respect to a signal power of each user equipment (UE) within the 1^{st}-tier clusters.

2. The method of claim 1, wherein each TRP set comprises a first TRP and a second TRP in a back-to-back configuration in which antenna elements of the first TRP are positioned to radiate in an opposite direction from antenna elements of the second TRP.

3. The method of claim 1, wherein:
each 1^{st}-tier cluster is defined as a union of three cell site sectors from three different cell sites to provide 1^{st}-tier clustering;
each cell site sector comprises two sub-cells; and
each 1^{st}-tier cluster does not overlap with another 1^{st}-tier cluster.

4. The method of claim 3, wherein:
2^{nd}-tier clustering is defined to allow cooperation of cell site sectors not facilitated by the 1^{st}-tier clustering;
each 2^{nd}-tier cluster comprises a single sub-cell from each of three cell site sectors; and
each 2^{nd}-tier cluster is within an intersection of three 1^{st}-tier clusters.

5. The method of claim 1, wherein:
providing dynamic cluster selection comprises defining a first set of 1^{st}-tier clusters and a second set of 1^{st}-tier clusters;
each of the first set of 1^{st}-tier clusters and the second set of 1^{st}-tier clusters has six neighboring TRPs;
an initially associated cell site is configured to be attached to either one of the first set of 1^{st} tier clusters or one of the second set of 1^{st} tier clusters by choosing which other cell sites to append; and
each of the second set of 1^{st}-tier clusters is a superset of an associated 2^{nd}-tier cluster.

6. The method of claim 1, further comprising utilizing one or more power allocation schemes across multiple TRPs to satisfy one or more constraints.

7. The method of claim 6, wherein the one or more power allocation schemes comprises equal power allocation across TRPs or weighted equal power allocation across TRPs.

8. The method of claim 6, wherein the one or more power allocation schemes comprises flexible power allocation across TRPs.

9. The method of claim 6, wherein the one or more power allocation schemes comprises prime power allocation or local prime allocation across TRPs.

10. The method of claim 6, wherein the one or more power allocation schemes comprises two-stage prime power allocation across TRPs.

11. A system comprising:
one or more 2^{nd}-tier clusters located in an intersection of one or more adjacent 1^{st}-tier clusters to mitigate interference at cluster edges, the system configured to:
provide multi-tier clustering to enable joint transmission across multiple transmit-receive-point (TRP) sets; and
provide dynamic cluster selection to enable the joint transmission across the multiple TRP sets while mitigating interference at cluster edges based on selecting a tailored cluster with respect to a signal power of each user equipment (UE) within the 1^{st}-tier clusters.

12. The system of claim 11, wherein each TRP set comprises a first TRP and a second TRP in a back-to-back configuration in which antenna elements of the first TRP are positioned to radiate in an opposite direction from antenna elements of the second TRP.

13. The system of claim 11, wherein:
each 1^{st}-tier cluster is defined as a union of three cell site sectors from three different cell sites to provide 1^{st}-tier clustering;
each cell site sector comprises two sub-cells; and
each 1^{st}-tier cluster does not overlap with another 1^{st}-tier cluster.

14. The system of claim 13, wherein:
2^{nd}-tier clustering is defined to allow cooperation of cell site sectors not facilitated by the 1^{st}-tier clustering;
each 2^{nd}-tier cluster comprises a single sub-cell from each of three cell site sectors; and
each 2^{nd}-tier cluster is within an intersection of three 1^{st}-tier clusters.

15. The system of claim 11, wherein:
the system is further configured to define a first set of 1^{st}-tier clusters and a second set of 1^{st}-tier clusters;
each of the first set of 1^{st}-tier clusters and the second set of 1^{st}-tier clusters has six neighboring TRPs;
an initially associated cell site is configured to be attached to either one of the first set of 1^{st} tier clusters or one of the second set of 1^{st} tier clusters by choosing which other cell sites to append; and
each of the second set of 1^{st}-tier clusters is a superset of an associated 2^{nd}-tier cluster.

16. The system of claim 11, wherein the system is configured to utilize one or more power allocation schemes across multiple TRPs to satisfy one or more constraints.

17. The system of claim 16, wherein the one or more power allocation schemes comprises equal power allocation across TRPs or weighted equal power allocation across TRPs.

18. The system of claim 16, wherein the one or more power allocation schemes comprises flexible power allocation across TRPs.

19. The system of claim 16, wherein the one or more power allocation schemes comprises prime power allocation or local prime allocation across TRPs.

20. The system of claim 16, wherein the one or more power allocation schemes comprises two-stage prime power allocation across TRPs.
